(19) United States
(12) Patent Application Publication
(10) Pub. No.: US 2010/0288383 A1
(43) Pub. Date: Nov. 18, 2010

(54) VALVE APPARATUS AND SYSTEM

(76) Inventors: HARMON HOUGHTON, SANTA FE, NM (US); REINHOLD WIRTH, SANDIA PARK, NM (US)

Correspondence Address: THE ADAMS KENNEDY LAW FIRM, LLC, 901 RIO GRANDE BLVD. NW, SUITE H262, ALBUQUERQUE, NM, 87111, US

(21) Appl. No.: 12/779,838

(22) Filed: May 13, 2010

Related U.S. Application Data
(60) Provisional application No. 61/177,713, filed on May 13, 2009.
(60) Provisional application No. 61/186,694, filed on Jun. 12, 2009.
(60) Provisional application No. 61/186,611, filed on Jun. 12, 2009.

(51) Int. Cl. F16K 11/06

(52) U.S. Cl. 137/625.17

(57) ABSTRACT

A faucet control system and valve is described herein. The valve can include a cylinder-type valve that is configured to control the temperature and flow rate of water to the faucet. The valve of the preferred embodiment can include a body defining a first cavity along a longitudinal axis; a first inlet port disposed in the body intersecting the first cavity; a first outlet port disposed in the body and intersecting the first cavity; and a rod selectively positionable within the first cavity of the body and defining a second cavity therein. The rod can include a first rod port intersecting the second cavity and a second rod port intersecting the second cavity such that in response to the rod being selectively positioned in a first position one of the first or second rod ports is substantially contiguous with one of the first inlet port or first outlet port.

The present application claims priority to provisional application Ser. No. 61/177,713 entitled “Retrofit Cylinder Valve” and filed on May 13, 2009, provisional patent application Ser. No. 61/186,694 entitled “Original Equipment Manufacturer Cylinder Valve” and filed on Jun. 12, 2009, and provisional patent application Ser. No. 61/186,611 entitled “Drainharvest Cylinder Valve” and filed on Jun. 12, 2009, the entirety of each of which is hereby incorporated by reference herein.

### BACKGROUND AND SUMMARY

1. Field of the Invention

The present invention relates generally to the field of mechanical engineering and more specifically to the fields of water delivery and water conservation.

2. History of the Related Art and Summary of the Present Invention

Traditional sinks and basins typically are equipped with “hand operated” faucets to provide a means of controlling flow rate and temperature mix of water used in a vast number of situations and applications. Flow rate and temperature mix adjustments require the use of the user's hands to manipulate faucet valves, or other mechanisms such as levers, or joysticks to control any desired output settings. In the use of conventional hand operated faucets, the single user must free, at minimum, one hand in order to manipulate the faucet control mechanism. This conventional use restricts the single user, in certain situations, full use of both hands to perform secondary operations while simultaneously controlling the faucet output.

In applications that require full use of both hands, the single user is subject to an initial presetting of the faucet output controls to the desired setting. Meanwhile, during the adjustment phase, water is flowing continuously and for a period while the user prepares and engages in the secondary operation. For example, in initial conditions where both hands are contaminated and is undesirable to spread the contamination to the faucet controls, the single user must rely on secondary measures to manipulate conventional faucet valves and mechanisms to initiate the desired output. Similarly, in post conditions where both hands have been thoroughly scrubbed and free of contamination and is undesirable to contract any contamination by direct hand contact with the faucet controls, the single user must rely on secondary measures to shut off the faucet output. Conventional faucets and faucet controls result in massive waste of clean water during normal use, not to mention the energy expended in the heating of wasted water, all of which only increases in a multi-user scenario.

Accordingly, the present invention has been conceived to simplify the use and maintenance of water faucet systems while also conserving water and energy. A hands free faucet control system and valve is described herein. The valve can include a cylinder-type valve that is configured to control the temperature and flow rate of water to the faucet. The valve of the preferred embodiment can include a body defining a first cavity along a longitudinal axis; a first inlet port disposed in the body intersecting the first cavity; a first outlet port disposed in the body and intersecting the first cavity; and a rod selectively positionable within the first cavity of the body and defining a second cavity therein. The rod can include a first rod port intersecting the second cavity and a second rod port intersecting the second cavity such that in response to the rod being selectively positioned in a first position one of the first or second rod ports is substantially contiguous with one of the first inlet port or first outlet port, thereby permitting or prohibiting the flow of water there through.

As noted in greater detail below, the system and valve of the present invention can control a water temperature and a water volume, thereby permitting complete hands free control of a faucet. In some embodiments described herein, the system and valve of the present invention can be controlled remotely by a user having a hands free user interface, thereby ensuring minimal water use and energy consumption.

These and other features and advantages of the system and valve apparatus of the present invention are described in detail herein with reference to the following figures.

### BRIEF DESCRIPTION OF THE FIGURES

FIG. 1 is a schematic diagram of a water faucet system in accordance with a preferred embodiment of the present invention.

FIG. 2 is a cross-sectional view of a valve apparatus of the water faucet system of the preferred embodiment.

FIG. 3 is a cross-sectional view of a valve apparatus of the water faucet system of the preferred embodiment.

FIG. 4 is a cross-sectional view of a valve apparatus of the water faucet system of the preferred embodiment.

FIG. 5 is a cross-sectional view of a valve apparatus of the water faucet system of the preferred embodiment.

FIG. 6 is a schematic diagram of a portion of the water faucet system of the preferred embodiment.

FIG. 7 is a schematic diagram of a portion of the water faucet system of the preferred embodiment.

FIG. 8 is a schematic diagram of a portion of the water faucet system of the preferred embodiment.

### DETAILED DESCRIPTION OF THE PREFERRED EMBODIMENTS

The present invention is described herein with reference to selected preferred embodiments and figures. As will be appreciated by those of skill in the art, the following detailed description and associated figures are exemplary in nature, and the scope of the present invention should be understood exclusively with reference to the appended claims.

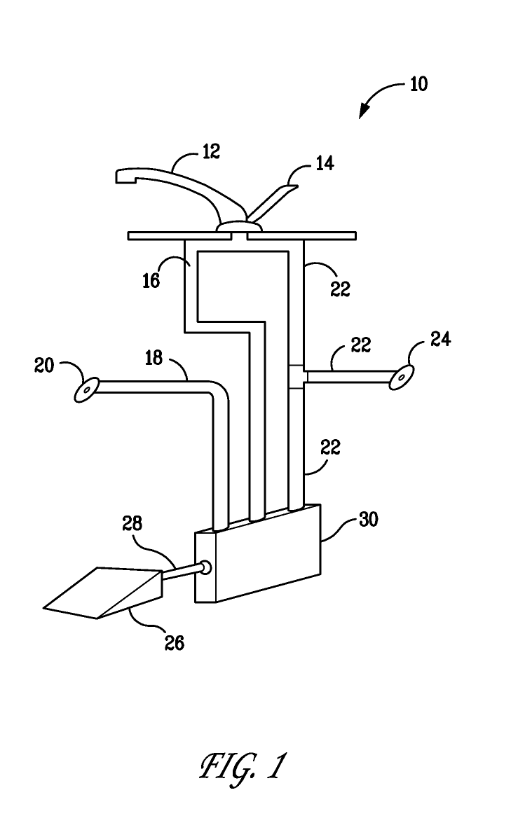

As shown in FIG. 1, one aspect of the present invention is a hands-free water faucet system 10 in accordance with a preferred embodiment of the present invention. The system 10 of the preferred embodiment can include a faucet 12 that is configured to be connected to a hot water source 20 and a cold water source 24. In one variation of the system 10 of the preferred embodiment, the faucet 12 can include a handle 14 or other suitable manual operating means for controlling a temperature or a flow volume of water from the hot water source 20 and the cold water source 24. Alternatively, the faucet 12 of the system 10 of the preferred embodiment can be designed without a handle 14 such that both the water temperature and flow volume are controllable by one or more of a valve 30 and a user interface 26 as described in detail herein. In another variation of the system 10 of the preferred embodiment, the faucet 12 can include a handle 14 and is configured for operation and control by one or more of the handle 14 or the valve 30 and a user interface 26 in a bypass mode, which is also described further herein.

As shown in FIG. 1, the system 10 of the preferred embodiment can include a valve 30 that is connected to the hot water source 20 through a hot water input pipe 18. Additionally, the valve 30 can be connected to the cold water source 24 through a cold water input pipe 22, which as shown in FIG. 1, can also be configured through an exemplary T-type fitting to supply cold water directly to the faucet 12. The valve 30 of the system 10 of the preferred embodiment can also include an output pipe 16 that conveys water of a predetermined temperature and flow volume to the faucet 12 as described further herein.

The system 10 of the preferred embodiment can further include a user interface 26 that is connected to the valve 30 and adapted to control the operational states of the valve 30 which in turn are determinative of the temperature and flow volume of the water output to the faucet 12. In accordance with selected variations of the system 10 of the preferred embodiment, the operational states of the valve 30 can include: an off state in which no water is transmitted from the valve 30 to the faucet 12, a hot state in which primarily hot water is transmitted from the valve 30 to the faucet 12, a cold state in which primarily cold water is transmitted from the valve 30 to the faucet 12, a mix state in which a predetermined mixture of hot and cold water is transmitted from the valve 30 to the faucet 12, and an optional bypass state in which the valve 30 is maintained in a hot state of predetermined volume but a user has the option of manipulating the handle 14 of the faucet 12 to determine a final volume and temperature of the water output by the faucet 12.

As described further herein, the user interface 26 of the system 10 of the preferred embodiment can include for example any suitable type of signal receiver and/or signal transmitter that is configured to receive and input from a user and provide a predetermined output to the valve 30 through a signal conduit 28. As an example, the user interface 26 can receive mechanical, electromechanical, piezoelectric, infrared, motion or other suitable inputs from a user and convert those inputs into a signal or instruction usable by the valve 30 to control one or more of its operational states. Suitable user interfaces 26 can include a mechanical foot pedal, an electromechanical foot pedal, a voice actuated electronic user interface, a touch actuated electronic user interface, a motion or infrared actuated electronic user interface and the like. The signals from the user interface 26 to the valve 30 can be determined by the type of actuation employed by the valve 30. Similarly, the conduit 28 can be matched to the type of output received by the user interface 26 and relayed to the valve 30. Accordingly, a mechanical foot pedal type user interface 26 can control the valve 26 via mechanical or electromechanical inputs; and a voice actuated type user interface 26 can control one or more electrical or electromechanical drivers or actuators on the valve 30. Other types of user interface 26 configurations are described in further detail below.

The valve 30 of the system 10 of the preferred embodiment can include a cylinder-type valve that is configured to control the temperature and flow rate of water to the faucet 12. A valve 30 of the preferred embodiment can include a body 32 defining a first cavity 40 along a longitudinal axis; a first inlet port 34 disposed in the body 32 intersecting the first cavity 40; a first outlet port 36 disposed in the body 32 and intersecting the first cavity 40; and a rod 42 selectively positionable within the first cavity 40 of the body 32 and defining a second cavity 44 therein. The rod 42 can include a first rod port 46 intersecting the second cavity 44 and a second rod port 48 intersecting the second cavity 44 such that in response to the rod 42 being selectively positioned in a first position one of the first or second rod ports 46, 48 is substantially contiguous with one of the first inlet port 34 or first outlet port 36, thereby permitting or prohibiting the flow of water there through.

FIGS. 2, 3, 4 and 5 illustrate one variation of the operation of the valve 30 of the preferred embodiment. As shown in the Figures, the body 32 portion of the valve 30 of the preferred embodiment can generally define the first cavity 40, within which the rod 42 is selectively positionable to control the flow of water to the faucet 12. The body 32 portion of the valve 30 of the preferred embodiment can include a first inlet port 34 and a second inlet port 38, each of which intersects the first cavity 40 and thereby functions to permit water to selectively flow there between. The body 32 portion of the valve 30 of the preferred embodiment can further include the first outlet port 36 intersecting the first cavity 40, which functions to permit the flow of water out of the valve 30 and towards the faucet 12.

In another variation of the valve 30 of the preferred embodiment, the body 32 portion of the valve 30 can be connected to a manifold 52 having three passages 54, 56, 58 that are substantially coextensive with the first inlet port 34, the second inlet port 38 and the first outlet port 36. The manifold 52 is an optional component that can be utilized to secure the body 32 portion of the valve 30 to the hot water input pipe 18, the cold water input pipe 22 and the output pipe 16 shown in the exemplary system 10 of FIG. 1. Alternatively, the valve 30 of the preferred embodiment can function without the manifold 52, in which case the hot water input pipe 18, the cold water input pipe 22 and the output pipe 16 can be connected directly to the body 32 portion of the valve 30. The manifold 52 can be arranged as a distinct component of the valve 30 that is connected to the body 32, or it can be an integral portion of the body 32 portion of the valve 30. The body 32 portion and the manifold 52 can be constructed as separate units or as an integrated unit, and each may be composed of the same or different materials, respectively, including but not limited to composite materials, plastics, ceramics, metals and/or metal alloys such as brass, or any suitable combination thereof.

In another variation of the valve 30 of the preferred embodiment, the first inlet port 34 can be configured as a hot water inlet port that is connectable to the hot water input pipe 18 either directly or through the manifold 52. Similarly, the second inlet port 38 can be configured as a cold water inlet port that is connectable to the cold water input pipe 22 either directly or through the manifold 52. The first outlet port 36 can be configured as a valve outlet that is connectable to the output pipe 16 either directly or through the manifold 52. In this example configuration, the valve 30 functions to receive both hot and cold water inputs and deliver no water, hot water, cold water or mixed temperature water directly to the faucet 12, depending upon the user input.

FIG. 2 illustrates a selected position of the rod 42 that corresponds to a state of the valve 30 of the preferred embodiment in which the water flow to the output pipe 16 and the faucet 12 is a mixture of hot and cold water, i.e. a mixed state. As shown, the rod 42 is positioned along the longitudinal axis of the first cavity 40 such that the first rod port 46 is substantially contiguous with the first inlet port 34, such that hot water can flow into the second cavity 44 of the rod 42. Furthermore, the rod 42 is positioned such that a third rod port 50 is substantially contiguous with the second inlet port 38, such that cold water can flow into the second cavity 44 of the rod 42. The rod 42 is also positioned such that the second rod port 48 is substantially contiguous with the first outlet port 36, such that the mixture of hot and cold water from the second cavity 44 of the rod 42 can flow through the first outlet port 36 and to the faucet 12 through the outlet pipe 16. Mixing of the hot and cold water occurs within the second cavity 44 of the rod 42, and precise variations of the water temperature can be controlled by controlling the degree of contiguousness between the first and second outlet ports 34, 38 and their respective first and third rod ports 46, 50.

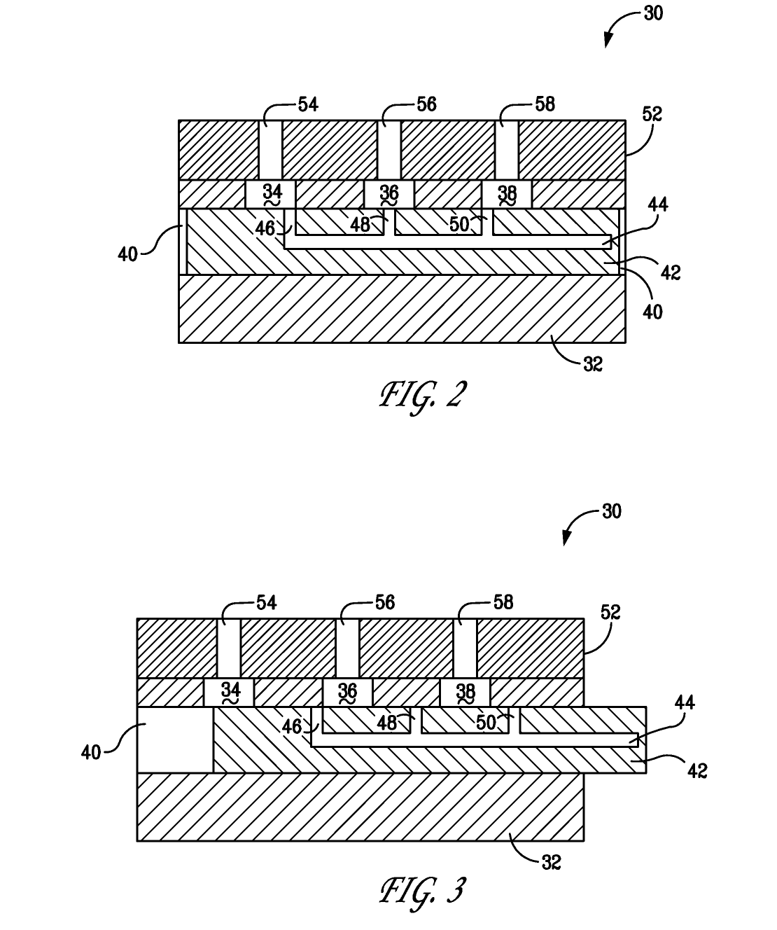

FIG. 3 illustrates a selected position of the rod 42 that corresponds to a state of the valve 30 of the preferred embodiment in which the water flow to the output pipe 16 and the faucet 12 is off, i.e. an off state. As shown, the rod 42 is selectively positioned along the longitudinal axis of the first cavity 40 such that none of the first and second outlet ports 34, 38 are aligned with their respective first and third rod ports 46, 50. Accordingly, in the example position shown in FIG. 3, there is no hot or cold water entering the second cavity 44 of the rod 42, and thus no flow of water to the faucet 12. As shown, the second rod port 48 is also aligned such that it is not contiguous with the first outlet port 36, although one of ordinary skill in the art will appreciate that the valve 30 of the preferred embodiment can be placed in an off state simply by blocking or occluding the first and second inlet ports 34, 38 and/or the first outlet port with the rod 42.

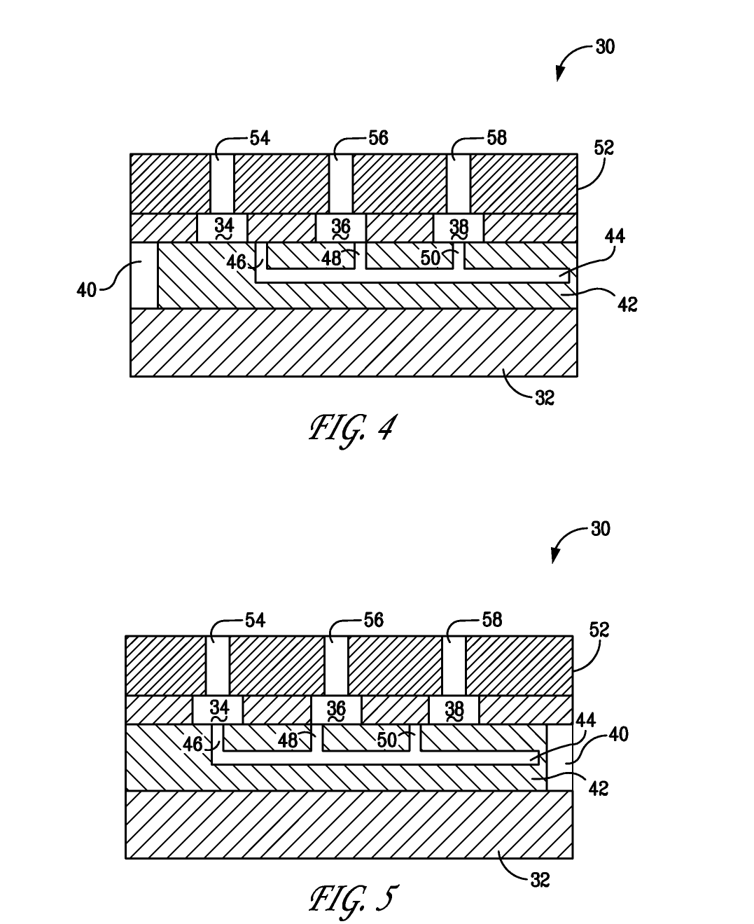

FIG. 4 illustrates a selected position of the rod 42 that corresponds to a state of the valve 30 of the preferred embodiment in which the water flow to the output pipe 16 and the faucet 12 is only cold water, i.e. a cold state. As shown, the rod 42 is positioned within the first cavity 40 such that the third rod port 50 is substantially contiguous with the second inlet port 38 and the second rod port 48 is substantially contiguous with the first outlet port 36. Furthermore, the rod 42 is positioned such that the first rod port 46 is not contiguous with the first inlet port 34. In the example configuration shown in FIG. 4, cold water is permitted to flow into the second cavity 44 through the second inlet port 38 and the third rod port 50. Cold water is further permitted to flow to the faucet 12 from the second cavity 44 through the second rod port 48 and the first outlet port 36. As is shown, there is no flow of hot water in the cold state as the rod 42 is positioned to prohibit the entry of hot water into the second cavity 44.

FIG. 5 illustrates a selected position of the rod 42 that corresponds to a state of the valve 30 of the preferred embodiment in which the water flow to the output pipe 16 and the faucet 12 is only hot water, i.e. a hot state. As shown, the rod 42 is positioned within the first cavity 40 such that the first rod port 46 is substantially contiguous with the first inlet port 34 and the second rod port 48 is substantially contiguous with the first outlet port 36. Furthermore, the rod 42 is positioned such that the third rod port 50 is not contiguous with the second inlet port 36. In the example configuration shown in FIG. 5, hot water is permitted to flow into the second cavity 44 through the first inlet port 34 and the first rod port 46. Hot water is further permitted to flow to the faucet 12 from the second cavity 44 through the second rod port 48 and the first outlet port 36. As is shown, there is no flow of cold water in the hot state as the rod 42 is positioned to prohibit the entry of cold water into the second cavity 44.

The system 10 of the preferred embodiment is operable with a faucet 12 that does not have any of its own valving or controls such as a handle 14. Alternatively, the system 10 of the preferred embodiment can also be installed and used with existing faucet systems in which the faucet 12 can be controlled independently of the valve 30 of the preferred embodiment. In the second instance, the valve 30 can be mounted to an existing sink or faucet system in a manner such as that shown in FIG. 1. This hybrid or retrofit configuration of the system 10 of the preferred embodiment allows a user to select between hands-free operation of the faucet 12 through the user interface 26 or manual operation of the faucet 12 through the handle 14 or other suitable control means.

In operation, should the user desire to employ the system 10 of the preferred embodiment in a retrofit configuration, he or she can control the valve 30 to enter into a bypass state in which the valve 30 operates as a conduit of the hot water only since the cold water piping 22 is already connected to the faucet 12 as shown in FIG. 1. The bypass state is substantially identical to the hot state described with reference to FIG. 5. As shown, the rod 42 is positioned within the first cavity 40 such that the first rod port 46 is substantially contiguous with the first inlet port 34 and the second rod port 48 is substantially contiguous with the first outlet port 36. Furthermore, the rod 42 is positioned such that the third rod port 50 is not contiguous with the second inlet port 36. In the bypass state shown in FIG. 5, hot water is permitted to flow into the second cavity 44 through the first inlet port 34 and the first rod port 46. Hot water is further permitted to flow to the faucet 12 from the second cavity 44 through the second rod port 48 and the first outlet port 36. As is shown in FIG. 1, cold water is supplied to the faucet 12 through the cold water piping 22. Accordingly, in the bypass state the faucet 12 is supplied with both hot and cold water, and the user can manually control the temperature and/or flow rate thereof through the existing valving and control mechanism of the faucet 12.

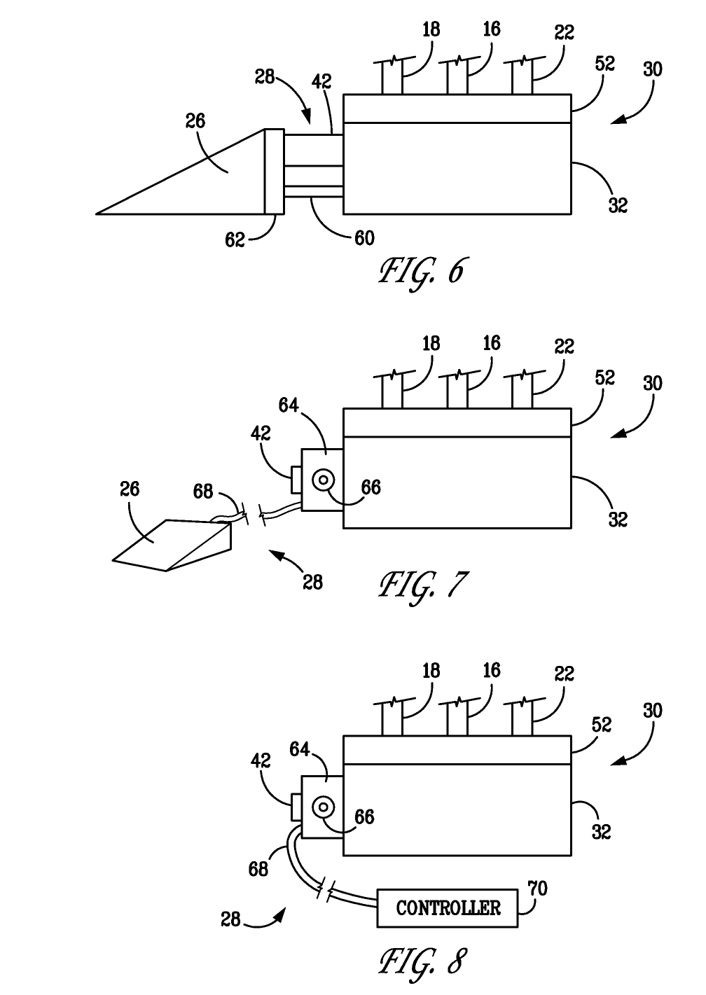

As noted above, the valve 30 of the preferred embodiment can be controlled in a hands-free manner through a variety of control mechanisms. FIGS. 6, 7 and 8 are illustrative of example embodiments of remote control for the system 10 of the preferred embodiment. As shown in FIG. 6, a mechanical foot pedal 26 can be connected to the valve 30 through a guide rail 60 and a mechanical actuator 62. The mechanical actuator 62 can be configured for and adapted to moving the rod 42 in a direction along the longitudinal axis of the body 32 portion of the valve 30 of the preferred embodiment. The guide rail 60 is an optional feature that functions to add structural support between the mechanical actuator 62 and the body 32 portion of the valve 30 of the preferred embodiment. Suitable mechanical actuation can be accomplished through any desirable combination of gears, levers and the like that are responsive to input at the mechanical foot pedal 26 and capable of converting the depressing motion of the mechanical foot pedal 26 into a linear or translational motion of the rod 42.

FIG. 7 illustrates another example embodiment of the system 10 of the preferred embodiment. As shown therein, an electromechanical foot pedal 26 can be connected to a motor mount 64, which in turn can be mounted on or near the valve 30 of the preferred embodiment. The motor mount 64 functions to contain a motor 66 that is adapted to drive the rod 42 in a direction substantially along the longitudinal axis of the body 32 portion of the valve 30. The electromechanical foot pedal 26 functions to translate the depressing motion of the user into an electrical signal that is usable to control the valve 30 of the preferred embodiment. Signals between the electromechanical foot pedal 26 and the motor 66 can be transmitted and received through one or more wires 68, or through wireless signals such as RF, infrared, WiFi and the like.

FIG. 8 illustrates another example embodiment of the system 10 of the preferred embodiment. As described above with reference to FIG. 7, the motor 66 can be adapted to drive the rod 42 in a direction substantially along the longitudinal axis of the body 32 portion of the valve 30. A controller 70 can be connectable to the motor 66 through one or more wires 68, or through wireless signals such as RF, infrared, WiFi and the like. The controller 70 can be any suitable interface for receiving inputs from a user and converting those inputs into electrical signals usable by the motor 66. Example controllers 70 can include a motion-activated controller, a voice-activated controller, a touch-activated controller or any other suitable combination thereof.

In another variation of the system 10 of the preferred embodiment, the controller 70 can be a digital to analog (DAC) controller adapted to receive digital control signals from a user and convert them into analog signals by which the valve 30 can be actuated. The DAC controller can further include a memory module for logging data related to the water usage patters and consumption of the user. Possible user interfaces 26 for the DAC controller can include for example a voice actuation module, a foot platform or trackpad that translates position and/or pressure signals into related states of the valve 30, or a motion actuated or PIR-type sensor that translates position and/or radiation signals into related states of the valve 30.

The present invention has been described herein with reference to particular preferred embodiments as well as the example embodiments and variations thereof depicted in the Figures. One of skill in the art will recognize that various modifications and additions can be made to that which has been described without deviating from the spirit and scope of the present invention, which is set forth in the following claims.

What is claimed is:

1. A valve apparatus comprising:
a body comprising a first cavity defining a first longitudinal axis;
a first inlet port disposed in the body intersecting the first cavity;
a first outlet port disposed in the body and intersecting the first cavity; and
a rod selectively positionable within the first cavity of the body and defining a second cavity therein, the rod comprising a first rod port intersecting the second cavity and a second rod port intersecting the second cavity such that in response to the rod being selectively positioned in a first position one of the first or second rod ports is substantially contiguous with one of the first inlet port or first outlet port.

2. The apparatus of claim 1, further comprising a second inlet port disposed in the body and intersecting the first cavity.

3. The apparatus of claim 2, wherein the first inlet port comprises a hot water inlet port and the second inlet port comprises a cold water inlet port.

4. The apparatus of claim 3, wherein the rod is selectively positionable in a second position such that the hot water inlet is substantially contiguous with the first rod port such that hot water flows into the second cavity.

5. The apparatus of claim 4, further wherein the second rod port is substantially contiguous with the first outlet port.

6. The apparatus of claim 3, further comprising a third rod port.

7. The apparatus of claim 6, wherein the rod is selectively positionable in a third position such that the hot water inlet is substantially contiguous with the first rod port, the cold water inlet is substantially contiguous with the second rod port and the first outlet port is substantially contiguous with the third rod port.

8. The apparatus of claim 6, wherein the rod is selectively positionable in a fourth position such that the hot water inlet is substantially occluded by the rod, the cold water inlet is substantially contiguous with the second rod port and the first outlet port is substantially contiguous with the third rod port.

9. The apparatus of claim 6, wherein the rod is selectively positionable in a fifth position such that the hot water inlet, the cold water inlet and the first outlet port are substantially occluded by the rod.

10. A system comprising:
a faucet;
a first water line connected to the faucet;
a valve comprising:
a body defining a first cavity, a valve outlet connected to the first water line and contiguous with the first cavity, a hot water inlet connected to a hot water line and contiguous with the first cavity, and a cold water inlet connected to a cold water line and contiguous with the first cavity;
a rod selectively positionable within the first cavity, the rod further defining a second cavity, a rod hot water inlet contiguous with the second cavity, a rod cold water inlet contiguous with the second cavity, and a rod outlet contiguous with the second cavity; and
a controller adapted to control the selectively positionable rod such that in response to user input the rod is positionable within the first cavity to cause water of a predetermined volume and temperature to flow from the hot water line and the cold water line into the first water line.

11. The system of claim 10, wherein the rod is selectively positionable in a first position such that the hot water inlet is substantially contiguous with the rod hot water inlet such that hot water flows into the second cavity.

12. The system of claim 11, further wherein the rod outlet is substantially contiguous with the valve outlet.

13. The system of claim 10, wherein the rod is selectively positionable in a second position such that the hot water inlet is substantially contiguous with the rod hot water inlet, the cold water inlet is substantially contiguous with the rod cold water inlet and valve outlet is substantially contiguous with the rod outlet.

14. The system of claim 10, wherein the rod is selectively positionable in a third position such that the hot water inlet is substantially occluded by the rod, the cold water inlet is substantially contiguous with the rod cold water inlet and the valve outlet is substantially contiguous with the rod outlet.

15. The system of claim 10, wherein the rod is selectively positionable in a fourth position such that the hot water inlet, the cold water inlet and the valve outlet are substantially occluded by the rod.
